(19) United States
(12) Patent Application Publication
(10) Pub. No.: US 2010/0114979 A1
(43) Pub. Date: May 6, 2010

(54) SYSTEM AND METHOD FOR CORRELATING SIMILAR PLAYLISTS IN A MEDIA SHARING NETWORK

(75) Inventor: Steven L. Petersen, Los Gatos, CA (US)

Correspondence Address: WITHROW & TERRANOVA CT, 100 REGENCY FOREST DRIVE , SUITE 160, CARY, NC, 27518, US

(73) Assignees: CONCERT TECHNOLOGY CORPORATION, Durham, NC (US); ELOY TECHNOLOGY, LLC, WILMINGTON, DE (US)

(21) Appl. No.: 12/259,711

(22) Filed: Oct. 28, 2008

(51) Int. Cl. G06F 17/30; G06F 7/06

(52) U.S. Cl. 707/803; 707/E17.032

(57) ABSTRACT

Methods and systems for aggregating playlists having similar content are provided. In general, a number of playlists are first obtained. Next, content of the playlists is analyzed to identify playlists that match to at least a defined threshold degree. Each group of two or more playlists having matching content is aggregated to provide a corresponding aggregate playlist.

### FIELD OF THE INVENTION

The present invention relates to aggregating playlists.

### BACKGROUND OF THE INVENTION

Playlists are the most common mechanism used to organize and arrange digital music. Further, some systems enable users to share playlists with one another. As a result, the number of playlists that a user has access to may be relatively large. Further, some of the playlists may contain similar content. Therefore, in order to optimize use of playlists in an environment having a relatively large number of playlists, there is a need for a method and system for aggregating playlists having similar content.

### SUMMARY OF THE INVENTION

The present invention relates to aggregating playlists. In general, a number of playlists are first obtained. Next, content of the playlists is analyzed to identify playlists that match to at least a defined threshold degree. Matching playlists are then aggregated to provide a corresponding aggregate playlist. In one embodiment, a user device obtains a number of shared playlists via a media sharing system, which includes a plurality of user devices including the user device connected by a network. Each of the user devices in the media sharing system hosts a shared media collection including a number of media items. In addition, at least some of the shared media collections include one or more shared playlists. Content of the shared playlists and, optionally, one or more playlists in a local media collection hosted by the user device is analyzed to identify playlists that match to at least a defined threshold degree. Matching playlists are then aggregated to provide a corresponding aggregate playlist.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates an exemplary media sharing system in which a process for aggregating playlists having similar content is implemented according to one embodiment of the present invention;

FIG. 2 illustrates the operation of the media sharing system of FIG. 1 according to one embodiment of the present invention;

FIGS. 3A-3E illustrates a Graphical User Interface (GUI) for presenting an aggregate media collection including one or more aggregate playlists to a user according to one embodiment of the present invention;

FIG. 4 is a flow chart illustrating a process for aggregating playlists according to one embodiment of the present invention;

FIG. 5 is a flow chart illustrating a process for aggregating playlists having at least a defined threshold amount of overlap according to one embodiment of the present invention;

FIGS. 6A and 6B illustrate a flow chart for a process for aggregating playlists based on one or more governing criteria according to another embodiment of the present invention;

FIGS. 7A-7C, 8A-8C, and 9 graphically illustrate the process of FIGS. 6A and 6B with respect to two exemplary playlists according to one embodiment of the present invention; and

FIG. 10 is a block diagram of one of the user devices of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to aggregating playlists. While the discussion below focuses on an embodiment of the present invention wherein playlists are aggregated as part of a media collection aggregation process in a media sharing system, the present invention is not limited thereto. The present invention is equally applicable to any type of device or system wherein it is desirable to aggregate playlists having similar content.

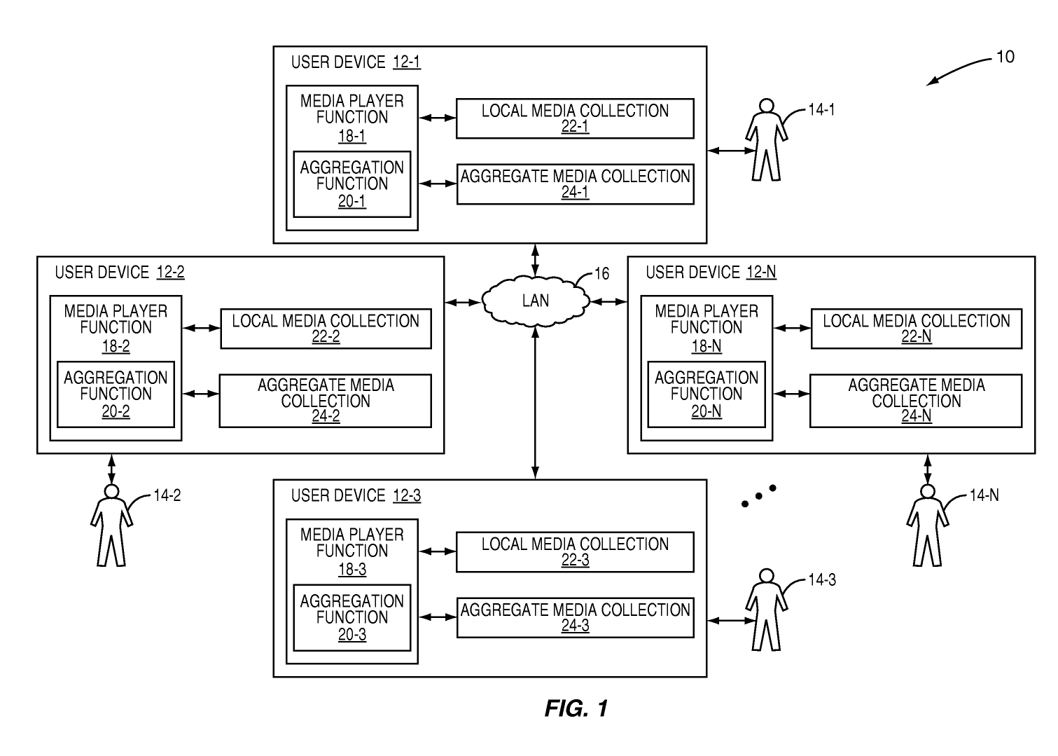

FIG. 1 illustrates an exemplary media sharing system 10 in which a process for aggregating playlists is implemented according to one embodiment of the present invention. In general, the media sharing system 10 includes a number of user devices 12-1 through 12-N having associated users 14-1 through 14-N. In this embodiment, the user devices 12-1 through 12-N are connected via a Local Area Network (LAN) 16 and are part of the same subnetwork. However, the present invention is not limited thereto. The user devices 12-1 through 12-N may alternatively be connected via a Wide Area Network (WAN), a global network such as the Internet, or the like. As yet another alternative, some of the user devices 12-1 through 12-N may be connected via a LAN while others are connected via a WAN or global network.

Each of the user devices 12-1 through 12-N may be, for example, a personal computer, a mobile smart phone, a set-top box, a portable media player, or the like. Looking at the user device 12-1, the user device 12-1 includes a media player function 18-1 which may be implemented in software, hardware, or a combination thereof. In addition to providing media playback capabilities, the media player function 18-1 includes an aggregation function 20-1. In an alternative embodiment, the aggregation function 20-1 may be implemented as a separate function. For example, if the media player function 18-1 is a software media player application, the aggregation function 20-1 may be implemented as a plug-in. Note that in an alternative embodiment, rather than having the aggregation functions 20-1 through 20-N, an aggregation function may be implemented in a server and operate to perform aggregation for each of the users 14-1 through 14-N. A local media collection 22-1 of the user 14-1 is stored at the user device 12-1. The local media collection 22-1 of the user 14-1 includes a number of media items owned by the user 14-1 and stored at the user device 12-1. The media items may include one or more audio items such as, for example, songs, podcasts, or audio books; one or more video items such as, for example, movies, television programs, or video clips; or the like. In addition, the local media collection 22-1 of the user 14-1 includes one or more playlists.

In general, the aggregation function 20-1 operates to generate an aggregate media collection 24-1 for the user 14-1 including media items in the local media collection 22-1 of the user 14-1 and media items from one or more remote shared media collections hosted by one or more of the other user devices 12-2 through 12-N. In this embodiment, as discussed below, the aggregation function 20-1 also generates the aggregate media collection 24-1 such that the aggregate media collection 24-1 also includes one or more aggregate playlists generated by aggregating playlists having similar content. More specifically, the aggregation function 20-1 analyzes content of playlists in the remote shared media collections and the local media collection 22-1 of the user 14-1 to identify playlists that have content that matches to at least a defined threshold degree. Each group of two or more matching playlists having matching content is aggregated into a corresponding aggregate playlist. In addition, the aggregation function 20-1 may aggregate playlists having the same title.

Like the user device 12-1, the other user devices 12-2 through 12-N include media player functions 18-2 through 18-N having corresponding aggregation functions 20-2 through 20-N. In addition, the other user devices 12-2 through 12-N include local media collections 22-2 through 22-N, and aggregate media collections 24-2 through 24-N.

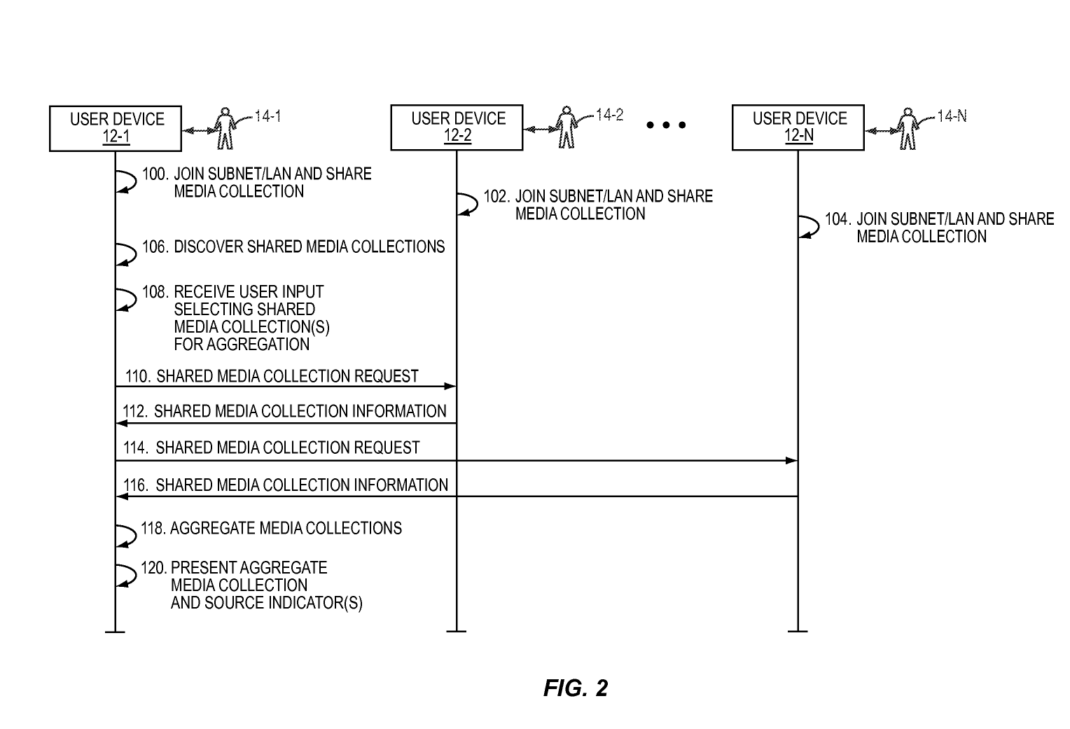

FIG. 2 illustrates the operation of the media sharing system 10 of FIG. 1 according to one embodiment of the present invention. First, the user devices 12-1 and 12-2 through 12-N join the LAN 16 by, for example, coming online (steps 100-104). Next, the aggregation function 20-1 of the user device 12-1 identifies, or discovers, media collections shared by the users 14-2 through 14-N of the user devices 12-2 through 12-N (step 106). For example, in a MAC OSX or Windows environment where the user devices 12-1 through 12-N are connected via the LAN 16, Bonjour may be used to identify the shared media collections of the users 14-2 through 14-N. The media collections shared by the users 14-2 through 14-N are preferably the local media collections 22-2 through 22-N of the users 14-2 through 14-N. However, the present invention is not limited thereto. In one exemplary alternative embodiment, the media collections shared by the users 14-2 through 14-N may be the aggregate media collections 24-2 through 24-N of the users 14-2 through 14-N. In this embodiment, the aggregation function 20-1 of the user device 12-1 presents a list of the shared media collections of the users 14-2 through 14-N to the user 14-1 and then receives user input from the user 14-1 selecting one or more of the shared media collections for aggregation (step 108). In this example, the user 14-1 selects at least the shared media collections of the users 14-2 and 14-N, which are hosted by the user devices 12-2 and 12-N, respectively.

The aggregation function 20-1 of the user device 12-1 then issues a shared media collection request to the user device 12-2 of the user 14-2 (step 110). In response, in this embodiment, the aggregation function 20-2 of the user device 12-2 returns information, which is also referred to herein as shared media collection information, identifying media items and playlists in the shared media collection of the user 14-2 to the user device 12-1 of the user 14-1 (step 112). Likewise, the aggregation function 20-1 of the user device 12-1 issues a shared media collection request to the user device 12-N of the user 14-N (step 114). In response, the aggregation function 20-N of the user device 12-N returns information identifying media items and playlists in the shared media collection of the user 14-N to the user device 12-1 of the user 14-1 (step 116). Note that shared media collection requests may also be issued to and shared media collection information received from other user devices from the user devices 12-3 through 12-N-1 (not shown) hosting shared media collections selected by the user 14-1.

Upon receiving the shared media collection information, the aggregation function 20-1 of the user device 12-1 aggregates or merges the local media collection 22-1 of the user 14-1 and the shared media collections to provide the aggregate media collection 24-1 of the user 14-1 (step 118). More specifically, in one embodiment, the aggregation function 20-1 of the user device 12-1 aggregates the shared media collection information identifying the media items in the shared media collections selected by the user 14-1 for aggregation and information identifying the media items in the local media collection 22-1 of the user 14-1 to provide a list of unique media items available either from the local media collection 22-1 of the user 14-1 or one of the shared media collections selected by the user 14-1 for aggregation. In addition, for each unique media item, a secondary list of available sources for the unique media item may be generated. Together, the list of unique media items and the corresponding secondary lists of sources for the unique media items form an aggregate collection of media items for the aggregate media collection 24-1 of the user 14-1.

In one embodiment, the aggregate collection of media items is the aggregate media collection 24-1. However, in the embodiment discussed herein, the aggregate media collection 24-1 includes the aggregate collection of media items and a number of playlists including one or more aggregate playlists, as discussed below. For more information regarding the media collection aggregation process, the interested reader is directed to commonly owned and assigned U.S. patent application Ser. No. 12/104,572, entitled METHOD AND SYSTEM FOR AGGREGATING MEDIA COLLECTIONS BETWEEN PARTICIPANTS OF A SHARING NETWORK, which was filed on Apr. 17, 2008 and is hereby incorporated herein by reference in its entirety. Note that while the discussion herein focuses on an embodiment where the shared media collections are aggregated with the local media collection 22-1 of the user 14-1, the present invention is not limited thereto. The user 14-1 may choose not to select his local media collection 22-1 for aggregation, in which case the shared media collections would be aggregated with one another to provide the aggregate media collection 24-1 of the user 14-1.

As mentioned above, in addition to including media items, the aggregate media collection 24-1 of the user 14-1 may include a number of playlists including one or more aggregate playlists. More specifically, the local media collection 22-1 of the user 14-1 as well the shared media collections selected by the user 14-1 for aggregation may include playlists. When generating the aggregate media collection 24-1 of the user 14-1, the aggregation function 20-1 of the user device 12-1 aggregates the playlists of the shared media collections selected by the user 14-1 and the playlists in the local media collection 22-1 of the user 14-1, assuming that the local media collection 22-1 of the user 14-1 has been selected either by the user 14-1 or by default for aggregation. When aggregating playlists, as discussed below, playlists having content that matches at least to a defined threshold degree are identified and aggregated or combined to provide corresponding aggregate playlists. In addition, preferably prior to combining playlists having matching content, playlists having the same title may be aggregated or combined. For example, an “80s” playlist of the user 14-1 may be combined with an “80s” playlist of the user 14-2 to provide an aggregate “80s” playlist including both the media items from the “80s” playlist of the user 14-1 and the media items from the “80s” playlist of the user 14-2.

In this exemplary embodiment, once the aggregate media collection 24-1 of the user 14-1 is generated, the aggregate media collection 24-1 and one or more source indicators are presented to the user 14-1 via, for example, a Graphical User Interface (GUI) (step 120). Each source indicator is presented in association with a corresponding element of the aggregate media collection 24-1 and operates to identify a source for that element of the aggregate media collection 24-1. The source of an element of the aggregate media collection 24-1 of the user 14-1 may be the local media collection 22-1 of the user 14-1 or one of the shared media collections selected by the user 14-1 for aggregation. As used herein, an element of the aggregate media collection 24-1 of the user 14-1 may be a playlist in the aggregate media collection 24-1 of the user 14-1 or a unique media item in the aggregate media collection 24-1 of the user 14-1. For more information, the interested reader is directed to U.S. patent application Ser. No. 12/251,490, entitled SOURCE INDICATORS FOR ELEMENTS OF AN AGGREGATE MEDIA COLLECTION IN A MEDIA SHARING SYSTEM, which was filed on Oct. 15, 2008 and is hereby incorporated herein by reference in its entirety.

At this point, the user 14-1 may utilize the aggregate media collection 24-1 in much the same manner as using the local media collection 22-1. For example, the user 14-1 may select media items from the aggregate media collection 24-1 for playback, generate playlists including media items from the aggregate media collection 24-1, generate smart or dynamic playlists that are populated from the aggregate media collection 24-1, play media items in an existing playlist or an aggregate playlist, or the like. In one embodiment, in order to provide playback of a media item that is from a shared media collection of another user, the media item is requested from the user device hosting the shared media collection and streamed from that user device to the user device 12-1 of the user 14-1. For example, if the user 14-1 initiates playback of a media item and that media item's source is the shared media collection hosted by the user device 12-2, the media player function 18-1 of the user device 12-1 requests the media item from the user device 12-2. In response, the user device 12-2, and specifically the media player function 18-2 of the user device 12-2, delivers the media item to the user device 12-1 for playback. In the preferred embodiment, the media item is delivered via streaming.

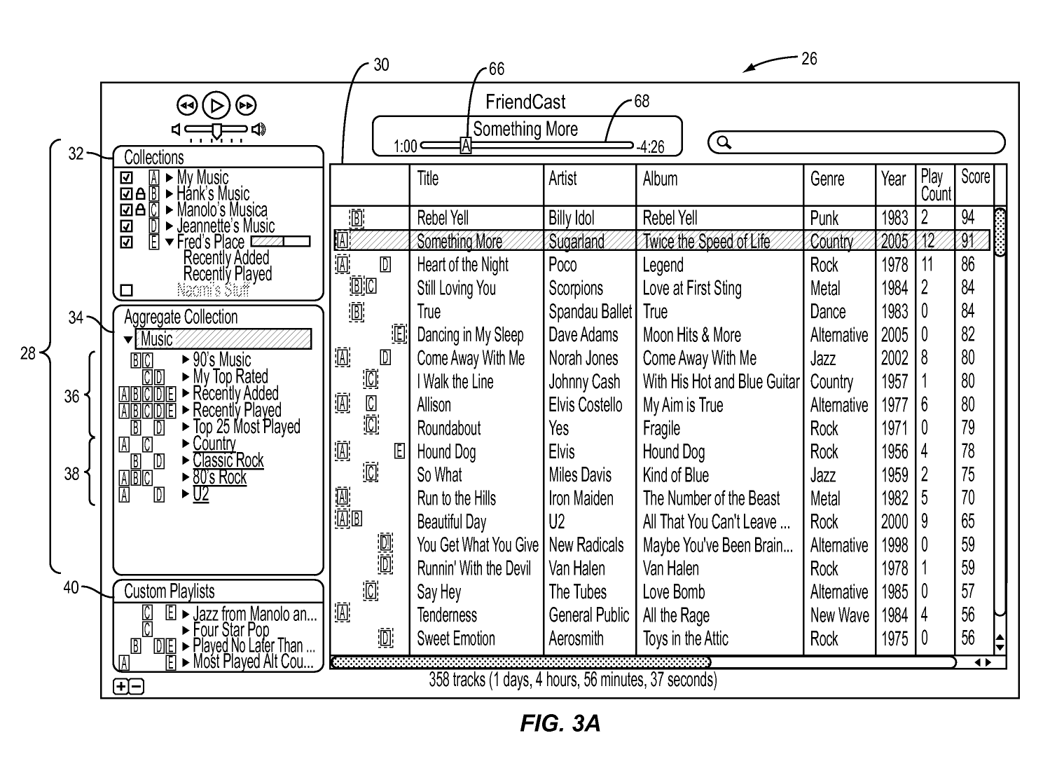

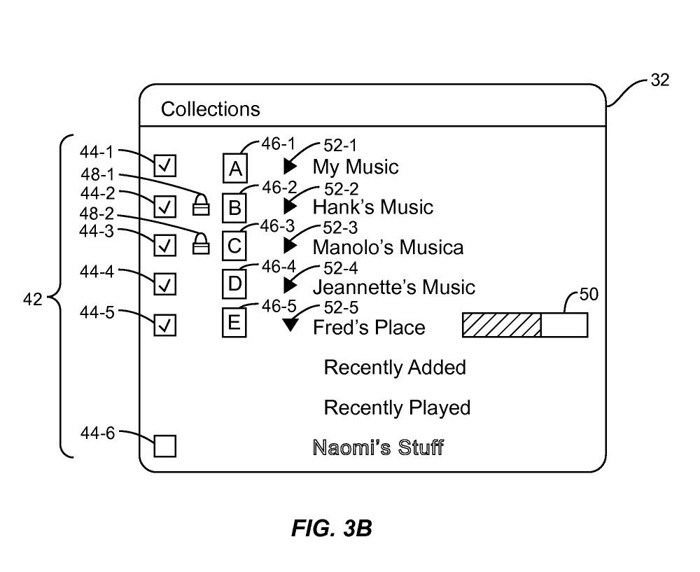

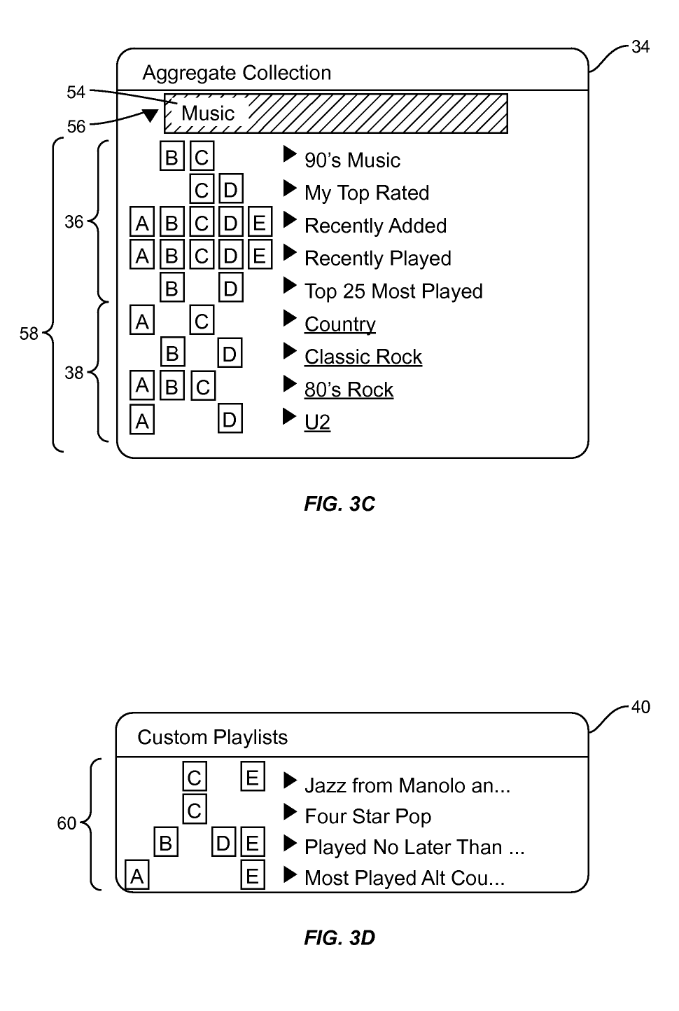

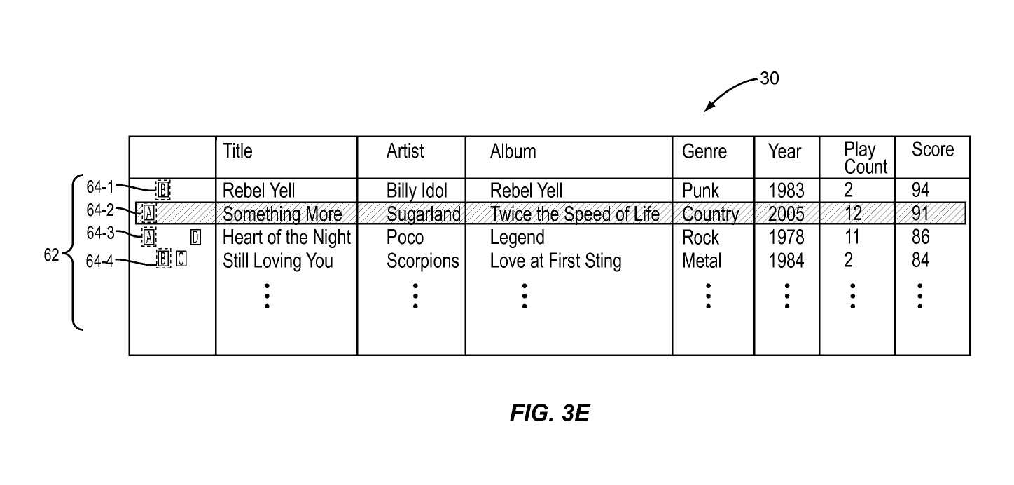

FIGS. 3A through 3E illustrate an exemplary GUI 26 for presenting an aggregate media collection to a user and enabling the user to interact and use the aggregate media collection, wherein the aggregate media collection includes one or more aggregate playlists according to one embodiment of the present invention. In this example, the media items are songs.

As shown in FIG. 3A, the GUI 26 includes a navigation area 28 and a display area 30. The navigation area 28 generally enables a corresponding user, which in this example is the user 14-1, to select media collections to be aggregated as well as to navigate his aggregate media collection 24-1. The navigation area 28 includes a media collection selection area 32 and an aggregate media collection area 34. The media collection selection area 32 is used to present a list of media collections available to the user 14-1 and to enable the user 14-1 to select two or more of the media collections for aggregation. In this example, the list of media collections available to the user 14-1 includes the local media collection 22-1 of the user 14-1, which has the title “My Music,” and five shared media collections having the titles “Hank's Music,” “Manolo's Musica,” “Jeannette's Music,” “Fred's Place,” and “Naomi's Stuff.” In this example, the user 14-1 has selected his local media collection 22-1 having the title “My Music” and the shared media collections having the titles “Hank's Music,” “Manolo's Musica,” “Jeannette's Music,” and “Fred's Place” for aggregation. Note that the maximum number of collections that may be selected for aggregation may be limited. For example, the media sharing system 10 may limit the number of shared media collections that a user may select for aggregation to five (5).

In this embodiment, each of the media collections selected for aggregation is assigned a unique source identifier. In this example, the source identifiers are alphabetic letters (A, B, C, etc.). However, any type of indicator enabling the user 14-1 to visually distinguish sources of elements of his aggregate media collection 24-1 may be used. For example, in another embodiment, each of the media collections selected for aggregation, which are also referred to herein as sources, may be assigned a unique color. The colors may then be used as source indicators by placing corresponding colored blocks or boxes next to the corresponding elements of the aggregate media collection 24-1 and/or by using text of the corresponding colors for the corresponding elements of the aggregate media collection 24-1.

The aggregate media collection area 34 generally enables the user 14-1 to navigate his aggregate media collection 24-1. In this example, the aggregate media collection 24-1 is an aggregate music collection. Thus, by selecting the “Music” identifier in the aggregate media collection area 34, a list of the unique songs in the aggregate music collection 24-1 of the user 14-1 is presented in the display area 30. Further, in this example, the “Music” identifier is hierarchical. In other words, the “Music” identifier may be expanded as shown to view a list of aggregate playlists in the aggregate music collection 24-1 of the user 14-1. Note that source identifiers are presented in association with each aggregate playlist to indicate the source or sources of media items in the aggregate playlist. In this example, the aggregate playlists include a number of aggregate playlists 36 resulting from the aggregation of playlists that have the same title and that are from multiple sources. Thus, in this example, both the shared media collection “Hank's Music” and the shared media collection “Manolo's Musica” include a playlist entitled “90's Music.” As a result, the “90's Music” playlist from the shared media collection “Hank's Music” and the “90's Music” playlist from the shared media collection “Manolo's Musica” are combined or merged to provide the aggregate playlist “90's Music.”

The aggregate playlists also include a number of aggregate playlists 38 resulting from the aggregation of playlists from multiple sources, where, for each of the aggregate playlists 38, the content of the playlists that were aggregated to provide the aggregate playlist matches to at least a defined threshold degree. Note that in this example, the aggregate playlists 38 are highlighted via underlining such that the user 14-1 is notified that the aggregate playlists 38 are in fact aggregate playlists resulting from the aggregation of playlists that match to at least a defined threshold degree. For example, the local media collection 22-1 of the user 14-1 may include a “Country” playlist that includes mostly songs by the artist “Garth Brooks,” and the shared media collection “Manolo's Musica” may include a “Garth Brooks” playlist including only songs by the artist “Garth Brooks.” As such, the aggregation function 20-1 of the user device 12-1 may identify the “Country” playlist and the “Garth Brooks” playlists as matching playlists and therefore aggregate these two playlists to provide the “Country” aggregate playlist. In a similar manner, the “Classic Rock,” “80's Rock,” and the “U2” aggregate playlists are generated. Note that, in another embodiment, this same type of aggregation process may be used even if two playlists have the same title.

In this example, the GUI 26 also includes a custom playlists area 40. The custom playlists area 40 enables the user 14-1 to define playlists created specifically for the aggregate media collection 24-1.

FIG. 3B is a blow-up of the media collection selection area 32 of FIG. 3A. As shown, the media collection selection area 32 includes a list of media collections 42 available to the user 14-1. The user 14-1 is enabled to select desired media collections for aggregation via corresponding check boxes 44-1 through 44-6. In this example, the user 14-1 has selected his local media collection 22-1, which is titled “My Music,” and the shared media collections “Hank's Music,” Manolo's Musica,” “Jeannette's Music,” and “Fred's Place” by activating the corresponding check boxes 44-1 through 44-5. Note that, in this example, the user 14-1 is limited to selecting at most five (5) media collections for aggregation. As such, since five (5) media collections have been selected, the shared media collection “Naomi's Stuff” is grayed-out and cannot be selected by the user 14-1 unless the user 14-1 deselects one of the other selected media collections. Note that the maximum number of media collections that may be selected is preferably a system-defined limit. However, in an alternative embodiment, the user 14-1 may be enabled to define the maximum number of media collections that may be aggregated.

Further, unique source indicators 46-1 through 46-5 (hereinafter source indicators 46-1 through 46-5) are assigned to the media collections selected for aggregation. In this example, the source indicators 46-1 through 46-5 are the letters A, B, C, D, and E positioned inside boxes. However, the present invention is not limited thereto. For example, the source indicators 46-1 through 46-5 may alternatively be colors. As discussed below, the source indicators 46-1 through 46-5 are presented in association with elements of the aggregate media collection 24-1 of the user 14-1 in order to identify the source or sources for the elements of the aggregate media collection 24-1 of the user 14-1.

Password-protection indicators 48-1 and 48-2 indicate that the corresponding media collections are password protected. As such, the user 14-1 must enter the correct passwords for the password protected media collections before the media collections can be aggregated or, alternatively, before the user 14-1 is enabled to play the media items from the password protected media collections. A progress indicator 50 may be used to show the progress of obtaining or downloading the shared media collection information for the corresponding shared media collection. Thus, in this example, the shared media collection information for the selected shared media collections other than “Fred's Place” have already been downloaded, and the download of the shared media collection information for “Fred's Place” is still in progress.

In this example, the identifiers for the selected media collections are hierarchical. As such, hierarchical controls 52-1 through 52-5 may be used to expand the identifiers to show a number of subgroups of media items within the corresponding media collections. In this example, the subgroups are playlists. As such, using the shared media collection “Fred's Place” as an example, the hierarchical control 52-5 may be activated to view the playlists included in the shared media collection “Fred's Place,” which are a “Recently Added” playlist and a “Recently Played” playlist.

FIG. 3C is a blow-up of the aggregate media collection area 34. As discussed above, the aggregate media collection area 34 generally enables the user 14-1 to navigate his aggregate media collection 24-1. In this example, the aggregate media collection 24-1 is an aggregate music collection. Thus, by selecting a “Music” identifier 54, a list of the unique songs in the aggregate media collection 24-1 of the user 14-1 is presented in the display area 30 (FIG. 3A). Further, in this example, the “Music” identifier 54 is hierarchical. As such, by selecting a hierarchical control 56, the user 14-1 can expand the “Music” identifier 54 to view a list of aggregate playlists 58 in the aggregate music collection 24-1 of the user 14-1.

One or more source indicators are presented in association with each of the aggregate playlists in order to identify the source or sources of the media items in the aggregate playlists. The source indicators presented in association with the aggregate playlists correspond to the source indicators 46-1 through 46-5 (FIG. 3B) assigned to the media collections selected for aggregation. As such, the user 14-1 can easily identify which source or sources contribute to each of the aggregate playlists. For example, the “90's Music” playlist has media items from the sources identified by the “B” and “C” source indicators, which in this example are the “Hank's Music” and “Manolo's Musica” shared media collections (FIG. 3B). As another example, the “Top 25 Most Played” playlist has media items from the sources identified by the “B” and “D” source identifiers, which in this example are the “Hank's Music” and “Jeannette's Music” shared media collections (FIG. 3B).

FIG. 3D is a blow-up of the custom playlists area 40 of FIG. 3A. One or more source indicators are presented in association with each custom playlist in a list of custom playlists 60 in order to identify the source or sources of the media items in the custom playlists. The source indicators presented in association with the custom playlists correspond to the source indicators 46-1 through 46-5 (FIG. 3B) assigned to the media collections selected for aggregation. As such, the user 14-1 can easily identify which sources contribute to each of the custom playlists. For example, the “Jazz from Manolo an . . . ” playlist has only media items from the sources identified by the “C” and “E” source indicators, which in this example are the “Manolo's Musica” and “Fred's Place” shared media collections (FIG. 3B).

FIG. 3E illustrates a list of media items 62 presented in the display area 30 of FIG. 3A. One or more source indicators are presented in association with each media item in the list of media items 62 in order to identify the source or sources for the media items. Again, the source indicators presented in association with the media items correspond to the source indicators 46-1 through 46-5 (FIG. 3B) assigned to the media collections selected for aggregation. As such, the user 14-1 can easily identify the source or sources for each media item in the list of media items 62. For example, the song “Rebel Yell” has only one source identified by the source indicator “B,” which in this example corresponds to the “Hank's Music” shared media collection. As another example, the song “Still Loving You” has two sources identified by the source indicator “B” and the source indicator “C,” which in this example correspond to the “Hank's Music” and “Manolo's Musica” shared media collections. Further, indicators 64-1 through 64-4 are used to identify one source for each of the media items from which the media item is to be obtained or streamed. For example, the song “Still Loving You” is to be obtained from the user device hosting “Hank's Music,” which is identified by the source indicator “B.” In this example, the indicators 64-1 through 64-4 are dashed boxes placed around the source indicators of the sources from which the media items are to be obtained. However, the present invention is not limited thereto. Other types of indicators 64-1 through 64-4 may be used.

Returning briefly to FIG. 3A, optionally, a source indicator 66 may also be used as the thumb of a playback progress bar 68 in order to identify the source of the currently playing media item. In this example, the song “Something More” is currently playing, and the source of the song “Something More” is identified by the source indicator “A,” which in this example is the local media collection 22-1 (“My Music”) of the user 14-1.

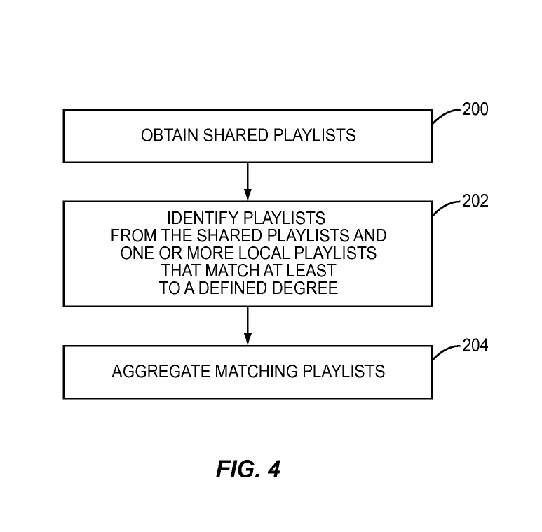

FIG. 4 illustrates a process for generating aggregate playlists according to one embodiment of the present invention. In the exemplary media sharing system 10 discussed above, the process for generating aggregate playlists is performed by the aggregation function 20-1 of the user device 12-1. However, the present invention is not limited thereto. The playlist aggregation process may be performed in any type of device or system wherein it is desirable to aggregate playlists.

First, a number of shared playlists are obtained (step 200). As discussed above, in the exemplary media sharing system 10, the shared playlists are received as part of the shared media collection information for a number of shared media collections selected for aggregation. Next, playlists from the shared playlists and, optionally, playlists from the local media collection 22-1 of the user 14-1 having content that matches at least to a defined threshold degree are identified (step 202). As discussed below, in one embodiment, matching playlists are playlists that have at least a threshold number or percentage of media items in common. In another embodiment, one or more governing criteria are identified for each playlist. Playlists having matching governing criteria are then correlated with respect to the governing criteria to provide corresponding correlation factors. Matching playlists are then identified as playlists having correlation factors greater than a defined threshold. In yet another embodiment, the user 14-1 may manually identify playlists to be aggregated. In a final embodiment, one or more of the techniques for identifying matching media items described above may be used in combination. Each group of two or more matching playlists is aggregated to provide a corresponding aggregate playlist (step 204).

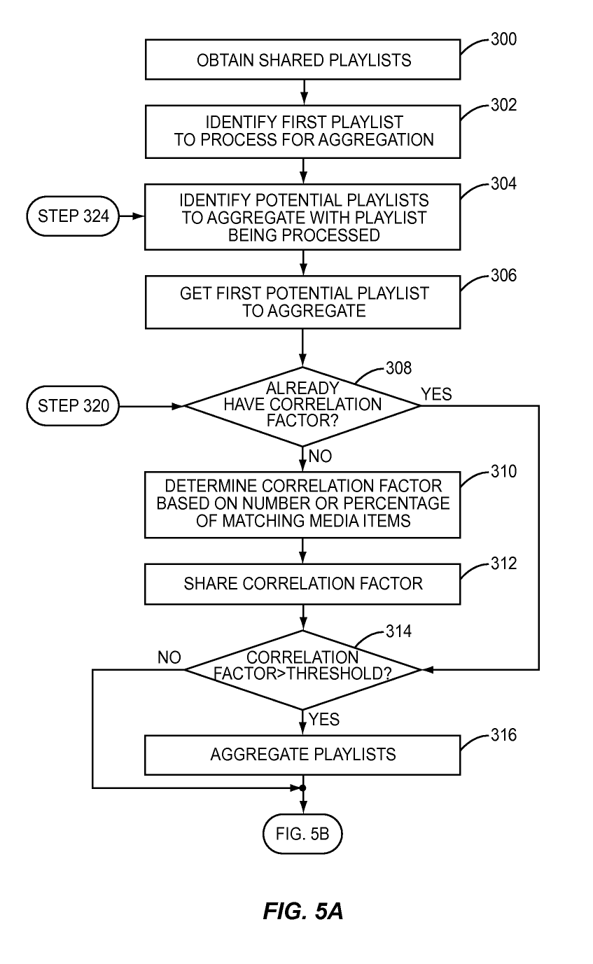

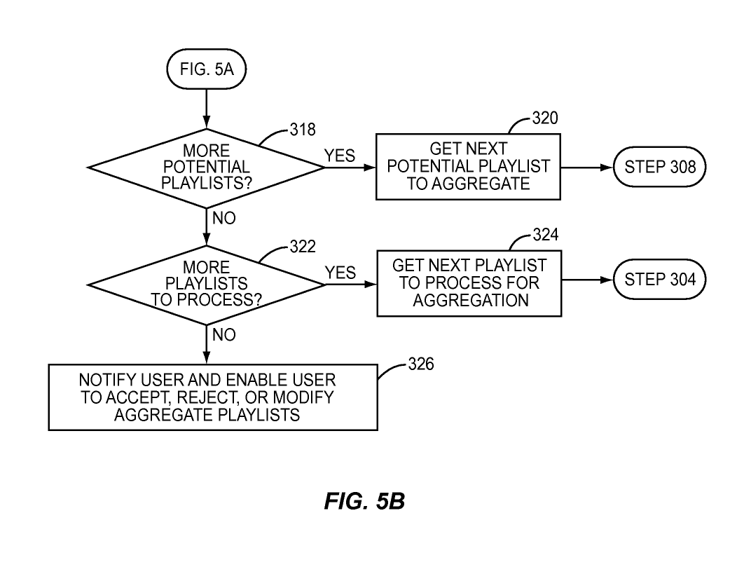

FIG. 5 is a flowchart illustrating a process for aggregating playlists having at least a defined threshold amount of overlapping content according to one embodiment of the present invention. Again, the aggregation function 20-1 of the user device 12-1 is used as an example. First, the aggregation function 20-1 obtains a number of shared playlists (step 300). As discussed above, in the exemplary media sharing system 10, the shared playlists are received as part of the shared media collection information for a number of shared media collections selected for aggregation. Next, the aggregation function 20-1 identifies a first playlist to process for aggregation from a group of playlists including the shared playlists and, optionally, one or more playlists in the local media collection 22-1 of the user 14-1 (step 302). The aggregation function 20-1 then identifies potential playlists to aggregate with the playlist being processed (step 304). For the first playlist to process for aggregation, the potential playlists to aggregate may include all of the other playlists from the shared media collections and the local media collection 22-1 of the user 14-1.

The aggregation function 20-1 then obtains or gets the first potential playlist to aggregate with the playlist being processed (step 306). A determination is then made as to whether a correlation factor for these two playlists already exists (step 308). As discussed below, in this embodiment, once the aggregation function 20-1 determines a correlation factor for two playlists, the aggregation function 20-1 shares the correlation factor with all or at least some of the other aggregation functions 20-2 through 20-N of the user devices 12-2 through 12-N. Likewise, all or at least some of the other aggregation functions 20-2 through 20-N share correlation factors that they have determined with the aggregation function 20-1. In this manner, the correlation process for correlating playlists in the media sharing system 10 is parallelized or distributed among the aggregation functions 20-1 through 20-N.

If the correlation factor for the two playlists already exists, the process proceeds to step 314. Otherwise, the aggregation function 20-1 determines a correlation factor for the two playlists based on a number or percentage of matching media items in two playlists (step 310). In other words, the correlation factor is a function of the number or percentage of media items that the two playlists have in common. In this embodiment, the aggregation function 20-1 shares the correlation factor for the two playlists with at least some of the other aggregation functions 20-2 through 20-N (step 312).

Whether proceeding from step 308 or step 312, a determination is then made as to whether the correlation factor is greater than a defined threshold for aggregation (step 314). If not, the process proceeds to step 318. If the correlation factor is greater than the defined threshold for aggregation, the playlists are aggregated or combined to provide a corresponding aggregate playlist (step 316). At this point, whether proceeding from step 314 or step 316, a determination is made as to whether there are more potential playlists for aggregation with the playlist being processed (step 318). If so, a next potential playlist to aggregate with the playlist being processed is obtained (step 320), and the process returns to step 308 and is repeated. Note that as a result of the iterative fashion of steps 308-318, any number of zero or more of the potential playlists may be aggregated with the playlist being processed. Therefore, there may be instances where the resulting aggregate playlist is formed by aggregating or combining two or more of the potential playlists with the playlist being processed.

Once there are no more potential playlists for aggregation to be processed, a determination is made as to whether there are more playlists to process for aggregation (step 322). If so, a next playlist to process for aggregation is obtained (step 324), and the process returns to step 304 and is repeated. In this embodiment, once there are no more playlists to process for aggregation, the aggregation function 20-1 notifies the user 14-1 of the aggregate playlists and enables the user 14-1 to accept, reject, or modify each of the aggregate playlists if desired (step 326). For example, the aggregate playlists may be highlighted in the GUI 26 (FIG. 3A). Upon hovering over an identifier (e.g., a title) of one of the aggregate playlists, the user 14-1 may be presented with a pop-up window that enables the user 14-1 to accept the aggregate playlist, reject the aggregate playlist, or modify the aggregate playlist. The user 14-1 may be enabled to modify the aggregate playlist by, for example, modifying a title of the aggregate playlist and/or modifying criteria used to generate the aggregate playlist, such as a threshold correlation factor for aggregation, the one or more governing criteria for the playlists aggregated to provide the aggregate playlist, or the like. Modified titles and modified governing criteria may be shared with all or some of the other aggregation functions 20-2 through 20-N. The modified titles may thereafter be presented to other users in the pop-ups for corresponding aggregate playlists in order to enable the other users to select those titles for their aggregate playlists if desired. The popularity of such titles may be maintained and presented to the users in order to assist them in selecting titles to use for aggregate playlists. In one embodiment, the titles of the aggregate playlists may also be propagated and made available to users such that users can use these titles for new playlists such that their new playlists are automatically aggregated with aggregate playlists having the same titles.

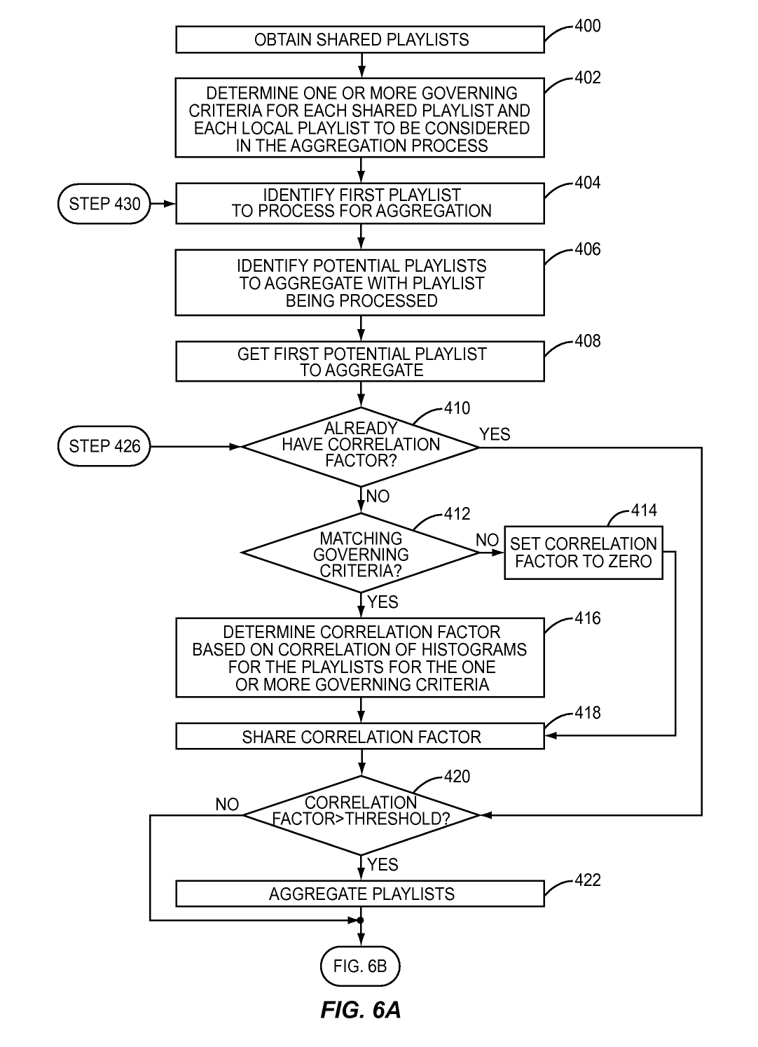

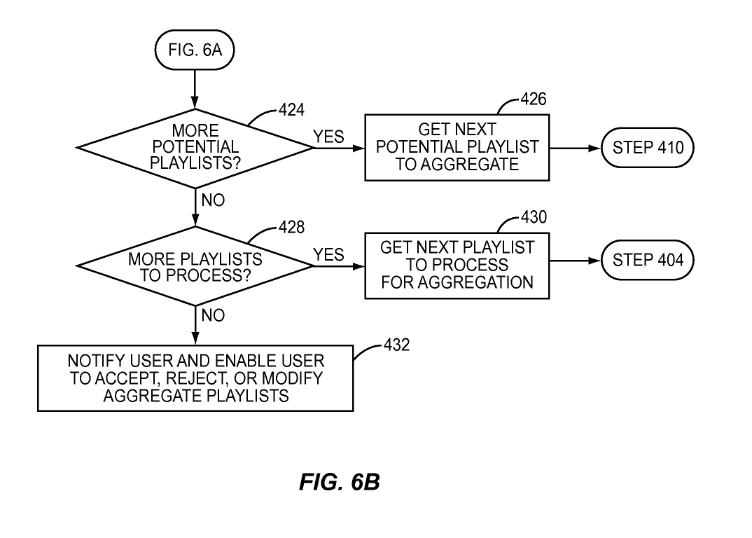

FIGS. 6A and 6B illustrate a flowchart for a process for aggregating playlists according to another embodiment of the present invention. Again, the aggregation function 20-1 of the user device 12-1 is used as an example. First, the aggregation function 20-1 obtains a number of shared playlists (step 400). As discussed above, in the exemplary media sharing system 10, the shared playlists are received as part of the shared media collection information for a number of shared media collections selected for aggregation. The aggregation function 20-1 then determines one or more governing criteria for each local playlist and each shared playlist to be considered in the aggregation process (step 402). More specifically, in one embodiment, in order to determine one or more governing criteria for a playlist, the aggregation function 20-1 obtains metadata describing each media item in the playlist. For instance, if the playlist is a playlist of songs, for each song, the aggregation function 20-1 obtains metadata such as an artist of the song, an album on which the song was released, a genre of the song, a decade in which the song was released, or the like. Then, the aggregation function 20-1 correlates the metadata for the media items in the playlist to provide a correlation factor for the playlist for each of a number of metadata categories (e.g., artist, album, genre, decade, or the like). In one embodiment, the metadata category having a highest correlation factor is identified as a governing criterion for the playlist. In another embodiment, the metadata categories having the M highest correlation factors are identified as governing criteria for the playlist, where M is a system-defined or user-configurable number greater than or equal to one. In yet another embodiment, one or more metadata categories having correlation factors greater than a defined threshold are identified as the governing criteria for the playlist. For example, if the playlist includes ten songs, and nine of the ten songs are from the Rock genre, then genre may be identified as a governing criterion for the playlist. In addition, if eight of the ten songs in the playlist are from the 1970s, then decade may also be identified as a governing criterion for the playlist.

In addition or alternatively, the user 14-1 may manually define one or more governing criteria for one or more of the playlists. Governing criteria defined by the user 14-1 for a playlist are given priority over governing criteria determined automatically for the same playlist. Further, the governing criteria defined by the user 14-1 may be shared with all or some of the other aggregation functions 20-2 through 20-N.

Next, the aggregation function 20-1 identifies a first playlist to process for aggregation from a group of playlists including the shared playlists and, optionally, one or more playlists in the local media collection 22-1 of the user 14-1 (step 404). The aggregation function 20-1 then identifies potential playlists to aggregate with the playlist being processed (step 406). For the first playlist to process for aggregation, the potential playlists to aggregate may include all of the other playlists from the shared media collections and the local media collection 22-1 of the user 14-1.

The aggregation function 20-1 then obtains or gets the first potential playlist to aggregate with the playlist being processed (step 408). A determination is then made as to whether a correlation factor for these two playlists already exists (step 410). In this embodiment, once the aggregation function 20-1 determines a correlation factor for two playlists, the aggregation function 20-1 shares the correlation factor with all or at least some of the other aggregation functions 20-2 through 20-N of the user devices 12-2 through 12-N. Likewise, all or at least some of the other aggregation functions 20-2 through 20-N share correlation factors that they have determined with the aggregation function 20-1. In this manner, the correlation process for correlating playlists in the media sharing system 10 is parallelized or distributed among the aggregation functions 20-1 through 20-N.

If the correlation factor for these two playlists already exists, the process proceeds to step 420. If the correlation factor for the two playlists does not already exist, the aggregation function 20-1 determines whether the one or more governing criteria for the two playlists match (step 412). If the one or more governing criteria for the two playlists do not match, a correlation factor for the two playlists is set to zero (step 414), and then the process proceeds to step 418. In an alternative embodiment, if the two playlists have at least one governing criterion in common, the correlation factor for the two playlists is not set to zero, and the process proceeds to step 416.

If the one or more governing criteria for the two playlist match, the aggregation function 20-1 then determines a correlation factor for the two playlists based on a correlation of histograms, or similar data structures, for the matching governing criteria of the two playlists (step 416). More specifically, for each of the playlists, a histogram is generated for the playlist with respect to each of the one or more matching criteria. In an alternative embodiment, the histogram(s) is generated in step 402. As an example, if the matching governing criterion is genre, histograms are generated for the two playlists with respect to genre, where, for each of the two playlists, the histogram includes the percentage or number of media items in the playlist for each of a number of predefined genres. For each of the one or more governing criteria, the histograms for the two playlists for the governing criterion are correlated. Then, a correlation factor representing a degree to which the content of the two playlists match is determined based on results of the correlation(s). In this embodiment, the aggregation function 20-1 shares the correlation factor for the two playlists with at least some of the other aggregation functions 20-2 through 20-N (step 418).

Whether proceeding from step 408 or step 416, a determination is then made as to whether the correlation factor is greater than a defined threshold for aggregation (step 420). If not, the process proceeds to step 424 (FIG. 6B). If the correlation factor is greater than the defined threshold for aggregation, the playlists are aggregated or combined to provide a corresponding aggregate playlist (step 422). At this point, whether proceeding from step 420 or step 422, a determination is made as to whether there are more potential playlists for aggregation with the playlist being processed (step 424). If so, a next potential playlist to aggregate with the playlist being processed is obtained (step 426), and the process returns to step 410 (FIG. 6A) and is repeated. Note that as a result of the iterative fashion of steps 410-424, any number of zero or more of the potential playlists may be aggregated with the playlist being processed. So, there may be instances where the resulting aggregate playlist is formed by aggregating or combining two or more of the potential playlists with the playlist being processed.

Once there are no more potential playlists for aggregation to be processed, a determination is made as to whether there are more playlists to process for aggregation (step 428). If so, a next playlist to process for aggregation is obtained (step 430), and the process returns to step 404 (FIG. 6A) and is repeated. In this embodiment, once there are no more playlists to process for aggregation, the aggregation function 20-1 notifies the user 14-1 of the aggregate playlists and enables the user 14-1 to accept, reject, or modify each of the aggregate playlists if desired (step 432).

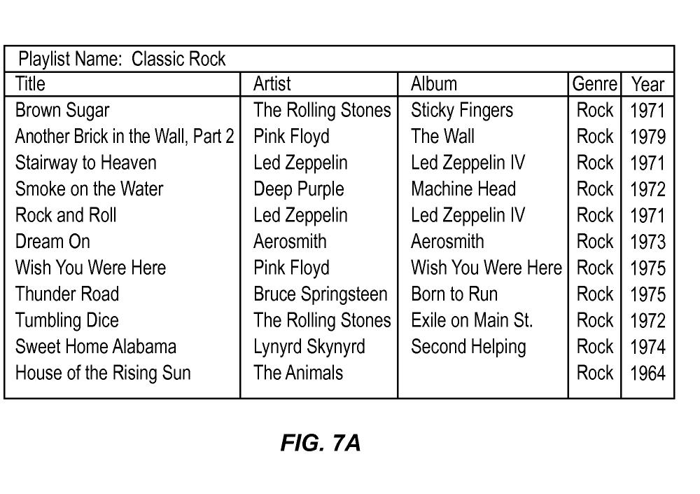

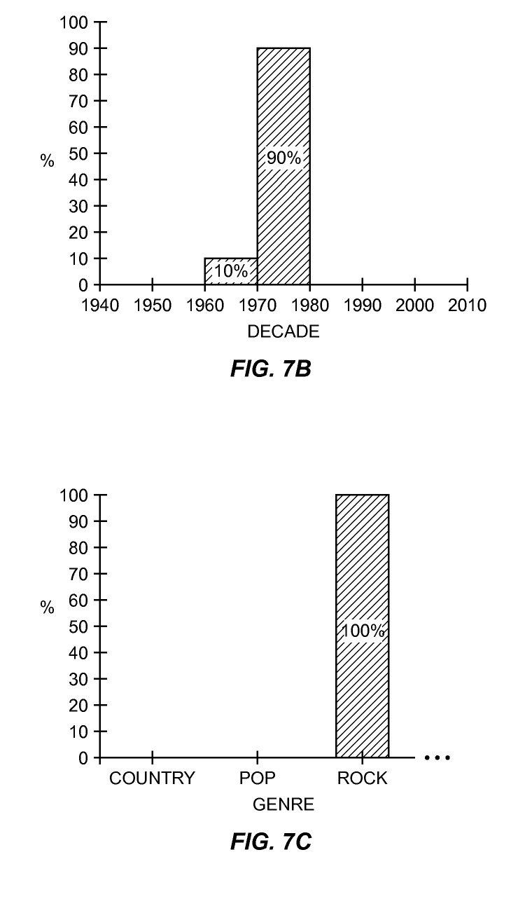

FIGS. 7A-7C, 8A-8C, and 9 graphically illustrate the process of FIGS. 6A and 6B according to an exemplary embodiment of the present invention. FIG. 7A illustrates a “Classic Rock” playlist. Based on a correlation of the metadata for the media items in the “Classic Rock” playlist, decade and genre are identified as the governing criteria for the “Classic Rock” playlist. More specifically, a correlation of the metadata for the media items in the “Classic Rock” playlist reveals that 11/11 songs in the playlist are from the Rock genre and that 10/11 songs in the playlist are from the 1970s. As such, genre and decade are identified as the governing criteria for the “Classic Rock” playlist. FIG. 7B illustrates a histogram for the “Classic Rock” playlist of FIG. 7A with respect to decade. As illustrated, ten percent of the songs in the “Classic Rock” playlist are from the 1960s and ninety percent of the songs in the “Classic Rock” playlist are from the 1970s. FIG. 7C illustrates a histogram for the “Classic Rock” playlist of FIG. 7A with respect to genre. As illustrated, one-hundred percent of the songs in the “Classic Rock” playlist are from the Rock genre.

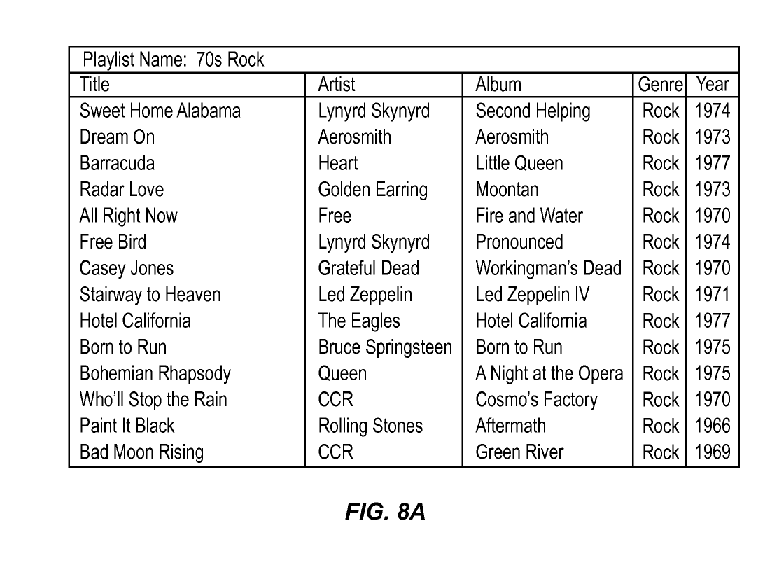

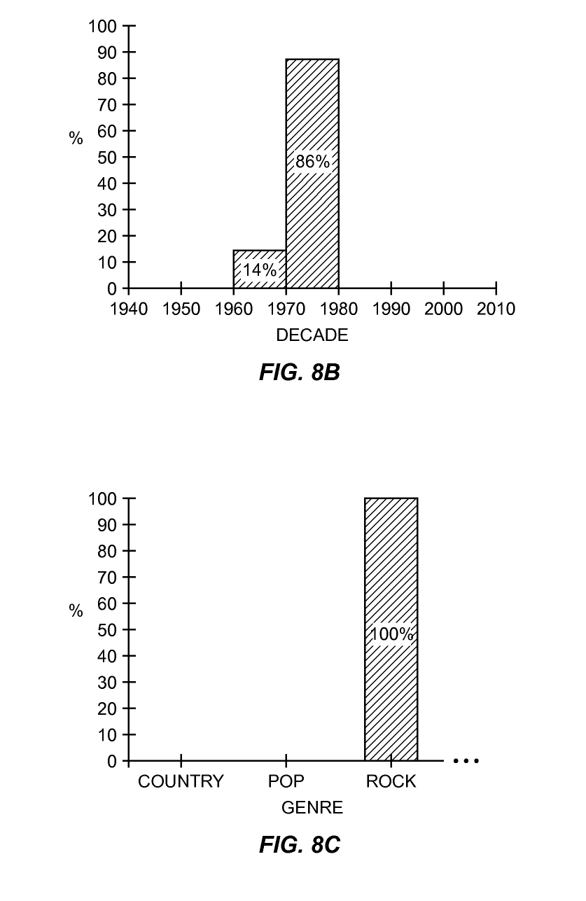

FIG. 8A illustrates a “70s Rock” playlist. Based on a correlation of the metadata for media items in the “70s Rock” playlist, decade and genre are identified as the governing criteria for the “70s Rock” playlist. More specifically, a correlation of the metadata for the media items in the “70s Rock” playlist reveals that 14/14 songs in the playlist are from the Rock genre and that 12/14 songs in the playlist are from the 1970s. As such, genre and decade are identified as the governing criteria for the “70s Rock” playlist. FIG. 8B illustrates a histogram for the “70s Rock” playlist of FIG. 8A with respect to decade. As illustrated, fourteen percent of the songs in the “70s Rock” playlist are from the 1960s and eighty-six percent of the songs in the “70s Rock” playlist are from the 1970s. FIG. 8C illustrates a histogram for the “70s Rock” playlist of FIG. 8A with respect to genre. As illustrated, one-hundred percent of the songs in the “70s Rock” playlist are from the Rock genre.

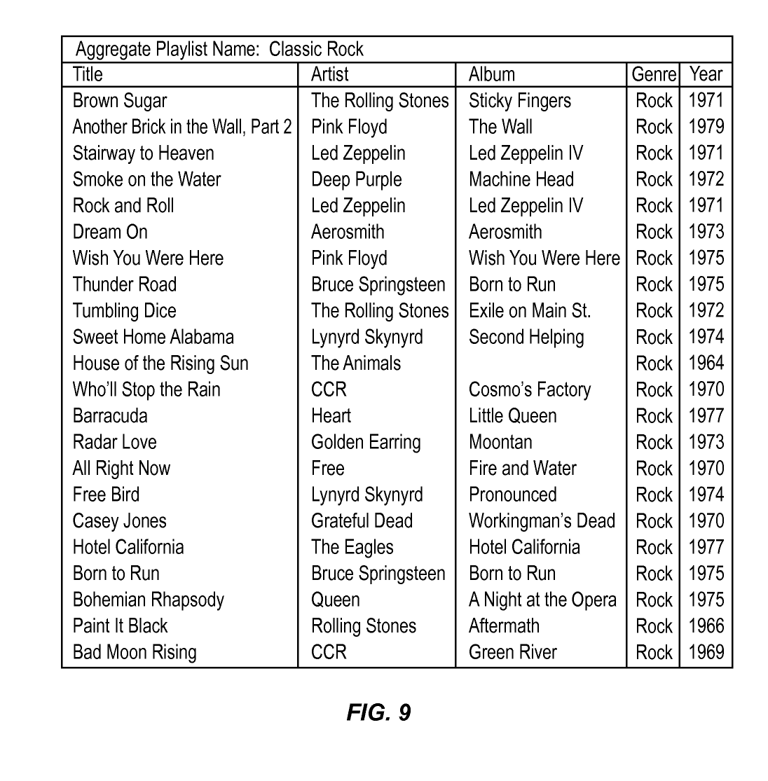

Assuming that the “Classic Rock” playlist of FIG. 7A is the playlist being processed for aggregation and that the “70s Rock” playlist of FIG. 8A is a potential playlist for aggregation, the governing criteria for these two playlists match. As such, a correlation factor for these two playlists is determined based on a correlation of the decade histograms for these two playlists and a correlation of the genre histograms for these two playlists. Since the decade and genre histograms for these two playlists are very similar, the correlation factor is high. As such, these two playlists are aggregated to provide the aggregate “Classic Rock” playlist illustrated in FIG. 9. The aggregate playlist may inherit the title of the playlist being processed for aggregation, which in this example is the title of the “Classic Rock” playlist of FIG. 7A. The user may thereafter change the title if desired. In another embodiment, the user may define preferences relating to the titles of aggregate playlists. For example, the user may indicate that the titles of his playlists from his local media collection are to have priority over titles of playlists with which his playlists are aggregated.

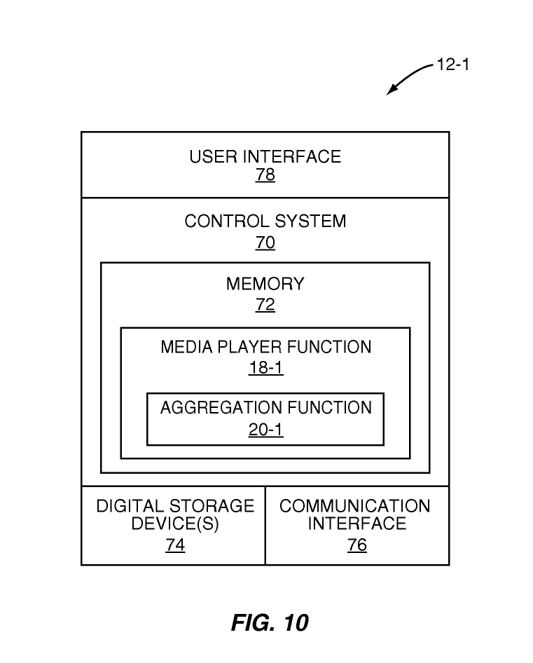

FIG. 10 is a block diagram of an exemplary embodiment of the user device 12-1 of FIG. 1. This discussion is equally applicable to the other user devices 12-2 through 12-N. In general, the user device 12-1 includes a control system 70 having associated memory 72. In this example, the media player function 18-1, including the aggregation function 20-1, is implemented in software and stored in the memory 72. However, the present invention is not limited thereto. The media player function 18-1, including the aggregation function 20-1, may be implemented in software, hardware, or a combination thereof. The user device 12-1 also includes one or more digital storage devices 74 such as, for example, one or more hard disk drives or the like. In one embodiment, the local media collection 22-1 and the aggregate media collection 24-1 are stored in the one or more digital storage devices 74. However, the present invention is not limited thereto. The user device 12-1 also includes a communication interface 76 communicatively coupling the user device 12-1 to the LAN 16. The communication interface 76 may be a wired or wireless connection. For example, the communication interface 76 may be an Ethernet connection, an IEEE 802.11x connection, or the like. The user device 12-1 also includes a user interface 78, which may include components such as, but not limited to, one or more user input devices, a display, a speaker, or the like.

The present invention provides substantial opportunity for variation without departing from the spirit or scope of the present invention. For example, while the discussion above focuses on aggregating playlists in the media sharing system 10 of FIG. 1, the present invention is not limited thereto. In general, the playlist aggregation process of the present invention may be used in any type of device or system desiring to aggregate playlists. For instance, the playlist aggregation process may be used by, for example, a user device such as a personal computer or portable media player to aggregate local playlists stored at the user device; a central server to aggregate playlists hosted by the central server; or the like. As another example, while the processes of FIG. 5 and FIGS. 6A and 6B are illustrated and discussed separately, the techniques for identifying matching playlists utilized therein may alternatively be used in combination.

Those skilled in the art will recognize improvements and modifications to the preferred embodiments of the present invention. All such improvements and modifications are considered within the scope of the concepts disclosed herein and the claims that follow.

What is claimed is:

1. A method comprising:
obtaining a plurality of playlists;
identifying at least two matching playlists from the plurality of playlists that have content that matches to at least a desired threshold degree; and
aggregating the at least two matching playlists to provide an aggregate playlist.

2. The method of claim 1 wherein identifying the at least two matching playlists from the plurality of playlists that have content that matches to at least the desired threshold degree comprises:
determining a correlation factor for at least two playlists of the plurality of playlists;
making a determination as to whether the at least two playlists match to at least the desired threshold degree based on the correlation factor; and
identifying the at least two playlists as the at least two matching playlists if the determination is made that the at least two playlists match to at least the desired threshold degree based on the correlation factor.

3. The method of claim 1 wherein identifying the at least two matching playlists from the plurality of playlists that have content that matches to at least the desired threshold degree comprises identifying at least two playlists having at least a threshold percentage of media items in common as the at least two matching playlists.

4. The method of claim 1 wherein identifying the at least two matching playlists from the plurality of playlists that have content that matches to at least the desired threshold degree comprises:
determining a governing criterion for each of at least a subset of the plurality of playlists;
identifying at least two playlists from the at least a subset of the plurality of playlists that have the same governing criterion;
making a determination as to whether to identify the at least two playlists as matching playlists based on a correlation of the at least two playlists with respect to the governing criterion of the at least two playlists; and
identifying the at least two playlists as the at least two matching playlists if the determination is made to identify the at least two playlists as matching playlists.

5. The method of claim 4 wherein the governing criterion for each playlist of the at least a subset of the plurality of playlists is a metadata category for metadata describing media items in the playlist.

6. The method of claim 4 wherein for each playlist of the at least a subset of the plurality of playlists, the governing criterion for the playlist is a metadata category for metadata describing media items in the playlist, the metadata category being one of a group consisting of: an artist metadata category, an album metadata category, a genre metadata category, and a time period metadata category.

7. The method of claim 4 wherein determining the governing criterion for each of the at least a subset of the plurality of playlists comprises, for each playlist of the at least a subset of the plurality of playlists:
correlating metadata for media items in the playlist to provide a correlation factor for each of a plurality of metadata categories; and
identifying a metadata category from the plurality of metadata categories that has a highest correlation factor as the governing criterion for the playlist.

8. The method of claim 4 wherein determining the governing criterion for each of the at least a subset of the plurality of playlists comprises, for each playlist of the at least a subset of the plurality of playlists:
correlating metadata for media items in the playlist to provide a correlation factor for each of a plurality of metadata categories; and
identifying a metadata category from the plurality of metadata categories that has a correlation factor that is greater than a predetermined threshold as the governing criterion for the playlist.

9. The method of claim 4 wherein determining the governing criterion for each of the at least a subset of the plurality of playlists comprises, for at least one playlist of the at least a subset of the plurality of playlists, receiving user input from an associated user defining the governing criterion for the at least one playlist.

10. The method of claim 1 wherein identifying the at least two matching playlists from the plurality of playlists that have content that matches to at least the desired threshold degree comprises:
determining a governing criterion for each of the at least a subset of the plurality of playlists;
identifying at least two playlists from the at least a subset of the plurality of playlists that have the same governing criterion;
for each playlist of the at least two playlists, obtaining a histogram for the playlist with respect to the governing criterion of the playlist;
determining a correlation factor for the at least two playlists based on a correlation of the histograms for the at least two playlists with respect to the governing criterion of the at least two playlists;
making a determination as to whether to identify the at least two playlists as matching playlists based on the correlation factor; and
identifying the at least two playlists as the at least two matching playlists if the determination is made to identify the at least two playlists as matching playlists based on the correlation factor.

11. The method of claim 1 further comprising:
presenting the aggregate playlist to an associated user; and
enabling the associated user to play the aggregate playlist.

12. The method of claim 1 further comprising:
presenting the aggregate playlist to an associated user; and
enabling the associated user to perform at least one action selected from a group consisting of: accept the aggregate playlist, reject the aggregate playlist, and modify the aggregate playlist.

13. The method of claim 1 wherein the method is a method of operating a user device and further comprises:
joining a media sharing system comprising a plurality of user devices including the user device connected via a network such that the user device has access to shared media collections hosted by other user devices of the plurality of user devices;
wherein obtaining the plurality of playlists comprises obtaining at least one of the plurality of playlists from the shared media collections and obtaining at least one of the plurality of playlists from a local media collection hosted by the user device.

14. The method of claim 13 wherein identifying the at least two matching playlists from the plurality of playlists that have content that matches to at least the desired threshold degree comprises:
determining a correlation factor for at least two playlists of the plurality of playlists;
making a determination as to whether the at least two playlists match to at least the desired threshold degree based on the correlation factor; and
identifying the at least two playlists as the at least two matching playlists if the determination is made that the at least two playlists match to at least the desired threshold degree based on the correlation factor;
wherein the method further comprises sharing the correlation factor for the at least two playlists with at least a subset of the other user devices.

15. A computer readable medium storing software for instructing a computing system to:
obtain a plurality of playlists;
identify at least two matching playlists from the plurality of playlists that have content that matches to at least a desired threshold degree; and
aggregate the at least two matching playlists to provide an aggregate playlist.

16. The computer readable medium of claim 15 wherein in order to identify the at least two matching playlists from the plurality of playlists that have content that matches to at least the desired threshold degree, the software is further adapted to instruct the computing system to:
determine a correlation factor for at least two playlists of the plurality of playlists;
make a determination as to whether the at least two playlists match to at least the desired threshold degree based on the correlation factor; and
identify the at least two playlists as the at least two matching playlists if the determination is made that the at least two playlists match to at least the desired threshold degree based on the correlation factor.

17. The computer readable medium of claim 15 wherein in order to identify the at least two matching playlists from the plurality of playlists that have content that matches to at least the desired threshold degree, the software is further adapted to instruct the computing system to identify at least two playlists having at least a threshold percentage of media items in common as the at least two matching playlists.

18. The computer readable medium of claim 15 wherein in order to identify the at least two matching playlists from the plurality of playlists that have content that matches to at least the desired threshold degree, the software is further adapted to instruct the computing system to:
determine a governing criterion for each of at least a subset of the plurality of playlists;
identify at least two playlists from the at least a subset of the plurality of playlists that have the same governing criterion;
make a determination as to whether to identify the at least two playlists as matching playlists based on a correlation of the at least two playlists with respect to the governing criterion of the at least two playlists; and
identify the at least two playlists as the at least two matching playlists if the determination is made to identify the at least two playlists as matching playlists.

19. The computer readable medium of claim 18 wherein the governing criterion for each playlist of the at least a subset of the plurality of playlists is a metadata category for metadata describing media items in the playlist.

20. The computer readable medium of claim 18 wherein for each playlist of the at least a subset of the plurality of playlists, the governing criterion for the playlist is a metadata category for metadata describing media items in the playlist, the metadata category being one of a group consisting of: an artist metadata category, an album metadata category, a genre metadata category, and a time period metadata category.

21. The computer readable medium of claim 18 wherein in order to determine the governing criterion for each of the at least a subset of the plurality of playlists, the software is further adapted to instruct the computing system to, for each playlist of the at least a subset of the plurality of playlists:
correlate metadata for media items in the playlist to provide a correlation factor for each of a plurality of metadata categories; and
identify a metadata category from the plurality of metadata categories that has a highest correlation factor as the governing criterion for the playlist.

22. The computer readable medium of claim 18 wherein in order to determine the governing criterion for each of the at least a subset of the plurality of playlists, the software is further adapted to instruct the computing system to, for each playlist of the at least a subset of the plurality of playlists:
correlate metadata for media items in the playlist to provide a correlation factor for each of a plurality of metadata categories; and
identify a metadata category from the plurality of metadata categories that has a correlation factor that is greater than a predetermined threshold as the governing criterion for the playlist.

23. The computer readable medium of claim 18 wherein in order to determine the governing criterion for each of the at least a subset of the plurality of playlists, the software is further adapted to instruct the computing system to, for at least one playlist of the at least a subset of the plurality of playlists, receive user input from an associated user defining the governing criterion for the at least one playlist.

24. The computer readable medium of claim 15 wherein in order to identify the at least two matching playlists from the plurality of playlists that have content that matches to at least the desired threshold degree, the software is further adapted to instruct the computing system to:
determine a governing criterion for each of at least a subset of the plurality of playlists;
identify at least two playlists from the at least a subset of the plurality of playlists that have the same governing criterion;
for each playlist of the at least two playlists, obtain a histogram for the playlist with respect to the governing criterion of the playlist;
determine a correlation factor for the at least two playlists based on a correlation of the histograms for the at least two playlists with respect to the governing criterion of the at least two playlists;
make a determination as to whether to identify the at least two playlists as matching playlists based on the correlation factor; and
identify the at least two playlists as the at least two matching playlists if the determination is made to identify the at least two playlists as matching playlists based on the correlation factor.

25. The computer readable medium of claim 15 wherein the software is further adapted to instruct the computing system to:
present the aggregate playlist to an associated user; and
enable the associated user to play the aggregate playlist.

26. The computer readable medium of claim 15 wherein the software is further adapted to instruct the computing system to:
present the aggregate playlist to an associated user; and
enable the associated user to perform at least one action selected from a group consisting of: accept the aggregate playlist, reject the aggregate playlist, and modify the aggregate playlist.

27. The computer readable medium of claim 15 wherein the computing system is a user device, and the software is further adapted to instruct the user device to:
join a media sharing system comprising a plurality of user devices including the user device connected via a network such that the user device has access to shared media collections hosted by other user devices of the plurality of user devices;
wherein in order to obtain the plurality of playlists, the software is further adapted to instruct the user device to obtain at least one of the plurality of playlists from the shared media collections and obtain at least one of the plurality of playlists from a local media collection hosted by the user device.

28. The computer readable medium of claim 27 wherein in order to identify the at least two matching playlists from the plurality of playlists that have content that matches to at least the desired threshold degree, the software is further adapted to instruct the user device to:
determine a correlation factor for at least two playlists of the plurality of playlists;
make a determination as to whether the at least two playlists match to at least the desired threshold degree based on the correlation factor; and
identify the at least two playlists as the at least two matching playlists if the determination is made that the at least two playlists match to at least the desired threshold degree based on the correlation factor;
wherein the software is further adapted to instruct the user device to share the correlation factor for the at least two playlists with at least a subset of the other user devices.

29. A system comprising:
a) a storage device adapted to store a plurality of playlists; and
b) a control system associated with the storage device and adapted to:
i) identify at least two matching playlists from the plurality of playlists that have content that matches to at least a desired threshold degree; and
ii) aggregate the at least two matching playlists to provide an aggregate playlist.
